(19) United States
(12) Patent Application Publication
(10) Pub. No.: US 2026/0088447 A1
(43) Pub. Date: Mar. 26, 2026

(54) COMPOSITION FOR FORMING COATING LAYER AND METHOD FOR MANUFACTURING SEPARATOR FOR ELECTROCHEMICAL DEVICE USING THE SAME

(71) Applicant: LG ENERGY SOLUTION, LTD., Seoul (KR)

(72) Inventors: Yu Bae KIM, Daejeon (KR); Byeong Kyu LEE, Daejeon (KR); Seung Hyun LEE, Daejeon (KR); Kyung Ryun KA, Daejeon (KR)

(73) Assignee: LG ENERGY SOLUTION, LTD., Seoul (KR)

(21) Appl. No.: 19/334,312

(22) Filed: Sep. 19, 2025

(30) Foreign Application Priority Data
Sep. 23, 2024 (KR) 10-2024-0128230
Aug. 22, 2025 (KR) 10-2025-0117575

(51) Int. Cl. H01M 50/446; C09D 7/40; C09D 7/45; C09D 7/61; C09D 7/65; C09D 133/04; H01G 11/52; H01M 50/42; H01M 50/434; H01M 50/443; H01M 50/449

(52) U.S. Cl. CPC H01M 50/446; C09D 7/45; C09D 7/61; C09D 7/65; C09D 7/69; C09D 133/04; H01M 50/42; H01M 50/434; H01M 50/443; H01M 50/449; H01G 11/52

(57) ABSTRACT

A composition for forming a coating layer includes inorganic particles, a binder, a solvent, and a dispersant. The dispersant includes polyacrylic acid (PAA) having a weight average molecular weight of 200,000 g/mol to 500,000 g/mol, and the content of the dispersant is 1 part by weight to 5 parts by weight relative to 100 parts by weight of the total weight of the inorganic particles.

### CROSS REFERENCES TO RELATED APPLICATIONS

This application is based on and claims priority from Korean Patent Application No. 10-2024-0128230, filed on Sep. 23, 2024, and No. 10-2025-0117575, filed on Aug. 22, 2025, with the Korean Intellectual Property Office, the disclosure of which is incorporated herein in its entirety by reference.

### TECHNICAL FIELD

The present disclosure relates to a composition for forming a coating layer, and a method of manufacturing a separator for an electrochemical device using the same.

### BACKGROUND

An electrochemical device converts chemical energy into electrical energy by using electrochemical reactions. In recent years, lithium secondary batteries, which have a high energy density, a high voltage, and a long cycle life and can be used in various fields, are being used widely.

A lithium secondary battery generates electricity through a chemical reaction in which lithium ions move between a cathode material and an anode material. The lithium ions of the cathode move to the anode while the battery is charged, and the lithium ions of the anode return to the cathode while energy is released and the battery is discharged. Here, there is a need for an electrolyte that acts as a movement passage for lithium ions between the cathode and the anode, and a separator that prevents contact between the cathode and the anode. In general, four components of a lithium ion battery refer to a cathode material, an anode material, an electrolyte, and a separator.

### SUMMARY

The present disclosure provides a composition for forming a coating layer (a coating layer forming composition) for forming a coating layer provided on any one surface of a porous polymer substrate of a separator for an electrochemical device. Since the coating layer forming composition contains polyacrylic acid (PAA) having a weight average molecular weight of 200,000 g/mol to 500,000 g/mol as a dispersant, a thin film of a coating layer can be formed by the coating layer forming composition.

Also, the present disclosure provides a method of manufacturing a separator for an electrochemical device, in which a coating layer with a thickness of 1.3 μm or less can be formed by using a coating layer forming composition.

In order to solve the above problems, the present disclosure provides a coating layer forming composition that includes inorganic particles, a binder, a solvent and a dispersant. The dispersant includes polyacrylic acid (PAA) having a weight average molecular weight of about 200,000 g/mol to 500,000 g/mol. The content of the dispersant is about 1 part by weight to 5 parts by weight relative to 100 parts by weight of the total weight of the inorganic particles.

In the coating layer forming composition, the viscosity measured at a temperature of 25° C. and a shear rate of 10 rpm may be about 5 cp to 30 cp.

The average particle size (D₅₀) of the solids of the coating layer forming composition may be about 1 μm to 1.5 μm.

The solid content of the coating layer forming composition may be about 30 wt % to 35 wt %.

The content of the inorganic particles may be about 80 parts by weight to 99 parts by weight relative to 100 parts by weight of the total solids of the coating layer forming composition.

The content of the binder may be about 0.5 parts by weight to 10 parts by weight relative to 100 parts by weight of the total solids of the coating layer forming composition.

The present disclosure provides a method of manufacturing a separator for an electrochemical device, the method including the steps of: applying the coating layer forming composition to at least one surface of a porous polymer substrate; and forming a coating layer by drying the coating layer forming composition. In the step of applying the coating layer forming composition, the coating layer forming composition is applied at a speed of about 3 mpm to 10 mpm.

In the step of applying the coating layer forming composition, the porous polymer substrate may be driven at a speed of about 10 mpm to 50 mpm.

In the step of forming the coating layer, the coating layer forming composition may be dried at a temperature of about 50° C. to 70° C.

Before the step of applying the coating layer forming composition, the step of preparing the composition may be further included.

The present disclosure provides a separator for an electrochemical device, in which the separator includes a porous polymer substrate and a coating layer disposed on at least one surface of the porous polymer substrate. The coating layer includes inorganic particles, a binder, and a dispersant. The dispersant contains polyacrylic acid (PAA) having a weight average molecular weight of about 200,000 g/mol to 500,000 g/mol, and the content of the dispersant is about 1 part by weight to 5 parts by weight relative to 100 parts by weight of the total weight of the inorganic particles. The thickness of the coating layer is about 1.3 μm or less.

The present disclosure provides an electrochemical device that includes a cathode, an anode and the separator for the electrochemical device. The separator for the electrochemical device is interposed between the cathode and the anode.

The coating layer forming composition according to the present disclosure contains polyacrylic acid (PAA) having a weight average molecular weight of about 200,000 g/mol to 500,000 g/mol as a dispersant, and thus has an advantage of enabling the formation of a thin-film coating layer.

Also, in the manufacturing method of the electrochemical device separator according to the present disclosure, the coating layer forming composition is coated on the porous polymer substrate at a speed of about 3 mpm to 10 mpm. Thus, there is an advantage in that it becomes possible to manufacture the separator for the electrochemical device in which a coating layer with a thickness of 1.3 μm or less is provided on at least one surface of the porous polymer substrate.

### BRIEF DESCRIPTION OF THE DRAWINGS

The drawings attached herewith are merely illustrative of embodiments of the present disclosure, and take on the role of further facilitating the understanding of the technical idea of the present disclosure along with the descriptions herein. Thus, the present disclosure should not be construed as being limited to those illustrated in the drawings.

FIG. 1 is a flow chart illustrating a manufacturing method of a separator for an electrochemical device, according to one embodiment of the present disclosure.

### DETAILED DESCRIPTION

Hereinafter, each component of the present disclosure will be described in more detail so that a person having ordinary skill in the technical field to which the present disclosure belongs can easily implement the present disclosure. However, this is merely an example, and the scope of the present disclosure is not limited by the following contents.

In this specification, the term “include” is used to enumerate materials, compositions, devices, and methods useful in the present disclosure, without limitation to the enumerated examples.

In this specification, the terms such as “about”, and “substantially” are used to mean ranges of numerical values or degrees or approximations thereof, taking into account inherent manufacturing and material tolerances, and are used to prevent infringers from unfairly using the disclosed contents in which precise or absolute figures provided for aiding the understanding of the present disclosure are mentioned.

In this specification, when one component is said to be provided “on” the other component, this does not exclude other components disposed between these, but means that other components may be further disposed unless specifically stated to the contrary.

In this specification, the “electrochemical device” may refer to a primary battery, a secondary battery or a supercapacitor. For example, the electrochemical device may be a lithium ion secondary battery and may be a pouch type, a cylindrical type, a prismatic type, or a coin type depending on the shape, but the shape of the lithium ion secondary battery is not limited thereto.

In this specification, “electrode” refers to both “cathode” and “anode”, and may mean that an electrode active material is applied to at least one surface of a material having conductivity without causing a chemical change in a electrochemical device, and then is dried. The material and the electrode active material are not limited in type as long as they can be used for the electrochemical device.

In this specification, “separator” may generally mean a functional separator in which a porous coating layer containing inorganic particles and a binder is formed on at least one surface of a porous polymer substrate such as a polyolefin substrate or non-woven fabric. Also, a separator has a porous characteristic including a large number of pores, and serves as a porous ion-conducting barrier that blocks electrical contact between an anode and a cathode in an electrochemical device while allowing ions to pass.

In this specification, the characteristic of being porous or having pores means that the object includes a plurality of voids or pores, and the voids or pores are connected to each other to form a structure that allows gaseous and/or liquid fluid to pass from one side surface to the other side surface of the object.

In this specification, the “porous polymer substrate” may refer to a porous film in which a plurality of pores is formed, which is a substrate that prevents an electrical short between a cathode and an anode through electrical insulation. For example, when the electrochemical device is a lithium secondary battery, the porous polymer substrate may be an ion-conducting barrier that blocks electrical contact between the cathode and the anode while allowing lithium ions to pass. At least a part of the pores may form a three-dimensional network through which the surface of the porous polymer substrate communicates with the inside, and then a fluid can pass through the porous polymer substrate via the pores.

In this specification, the “average diameter (D₅₀)” of particles refers to a particle diameter corresponding to the point of 50% of the cumulative volume, in the cumulative volume-based particle size distribution for measurement target particles. The average diameter may be measured by using a laser diffraction method. For example, measurement target powder is dispersed in a dispersion medium, and then is introduced into a commercially available laser diffraction particle size measurement device (e.g., Mastersizer 3000). Then, when the particles pass through laser beam, the particle size distribution is calculated by measuring the difference in the diffraction pattern according to the particle size. The average diameter (D₅₀) of particles may be measured by calculating the particle diameter at the point of 50% in the diameter-based cumulative distribution of the number of particles, in the measuring device.

In this specification, the “average particle size (D₅₀)” refers to an average particle size of the solids contained in a slurry such as a coating layer forming composition. For example, the average particle size of the solids in the coating layer forming composition refers to the average distribution of the sizes of all particles included in the coating layer forming composition such as inorganic particles, a binder, and a dispersant, and may be measured by the same method as that of the average diameter of the particles.

Among the components of an electrochemical device, a separator may include a polymer substrate having a porous structure located between a cathode and an anode. The separator performs a role of preventing an electrical short between the cathode and the anode by separating two electrodes from each other while performing a role of allowing electrolyte and ions to pass therethrough. Although the separator itself does not participate in an electrochemical reaction, physical properties such as wettability to the electrolyte, porosity, and thermal shrinkage may affect the performance and safety of the electrochemical device.

Therefore, in order to enhance these physical properties of the separator, various methods have been attempted, in which a coating layer is added to a porous polymer substrate, and various materials are added to the coating layer so as to improve the properties of the coating layer. As an example, in order to improve the mechanical strength of the separator, inorganic substances may be added to the coating layer, or inorganic substances or hydrates for improving the flame retardancy and heat resistance of the polymer substrate may be added to the coating layer.

Within the coating layer, inorganic particles may be linked to other inorganic particles by a polymer binder to form an interstitial volume, and lithium ions may move through the interstitial volume. The coating layer containing the polymer binder and the inorganic particles performs a role of assisting the movement of lithium ions through the separator while performing a role of preventing thermal shrinkage of the separator.

Meanwhile, when a thick coating layer is disposed on the porous polymer substrate to improve the thermal shrinkage problem of the separator, lithium ions may not smoothly pass through the separator because the porosity of the coating layer is relatively low compared to that of the porous polymer substrate. Thus, the resistance of the separator may be increased. Also, when the thickness of the coating layer is thick, the volume of electrodes and electrode active materials within a limited electrochemical device is inevitably reduced. As a result, there was also a problem in which the energy density of the electrochemical device was lowered. Accordingly, there is a growing demand for a coating layer that minimizes the thermal shrinkage problem of the porous polymer substrate but has a thin thickness. As a method for devising a separator for an electrochemical device including such a coating layer, research is being actively conducted on a coating layer forming composition capable of forming a thin film and a coating layer forming method using the same. For example, in order to produce such a coating layer of a thin film, the coating layer forming composition needs to have an excellent dispersibility.

In consideration of these points, the present disclosure provides a novel composition for forming a coating layer capable of forming a thin-film coating layer and a method of manufacturing a separator for an electrochemical device using the same.

Hereinafter, the present disclosure will be described in more detail.

A separator for an electrochemical device (an electrochemical device separator) according to one embodiment of the present disclosure includes a porous polymer substrate, and a coating layer provided on at least one surface of the porous polymer substrate and including a polymer binder and inorganic particles.

The present disclosure provides a composition for forming a coating layer (a coating layer forming composition) for producing the coating layer, in the electrochemical device separator including the porous polymer substrate and the coating layer. In the electrochemical device separator, the coating layer produced from the coating layer forming composition may be disposed on one surface or both surfaces of the porous polymer substrate.

According to one embodiment of the present disclosure, the coating layer forming composition includes inorganic particles, a binder, a solvent and a dispersant. The dispersant includes polyacrylic acid (PAA) having a weight average molecular weight of about 200,000 g/mol to 500,000 g/mol. The content of the dispersant is about 1 part by weight to 5 parts by weight relative to 100 parts by weight of the total weight of the inorganic particles.

In the coating layer forming composition, since polyacrylic acid (PAA) having a weight average molecular weight of about 200,000 g/mol to 500,000 g/mol is included as the dispersant, the dispersant may be effectively adsorbed onto the surface of the inorganic particles. For example, the weight average molecular weight of the polyacrylic acid may be about 200,000 g/mol or more, about 250,000 g/mol or more, about 300,000 g/mol or more, or about 350,000 g/mol or more, and may be about 500,000 g/mol or less, about 450,000 g/mol or less, about 400,000 g/mol or less, or about 350,000 g/mol or less. When the weight average molecular weight of the polyacrylic acid satisfies the above range, due to the high molecular weight, the long linear dispersant may be adsorbed over a large amount of inorganic particles. Therefore, electrostatic repulsion may be high between the large amount of inorganic particles to which the dispersant is adsorbed, due to steric hindrance. Then, the coating layer forming composition with reduced agglomeration between inorganic particles may have excellent dispersion stability. Therefore, when the coating layer forming composition having excellent dispersion stability is applied at a relatively low coating speed, it may be possible to form a coating layer in the form of a thin film. When the weight average molecular weight of the polyacrylic acid dispersant is maintained within the above range, the dispersion effect and the dispersion stability of the coating layer forming composition may be excellent and the thin film of the coating layer may also be easily formed. Also, the viscosity of the coating layer forming composition may be sufficiently low, and thus, the coating layer can be formed by using the coating layer forming composition having high dispersion stability.

Also, the polyacrylic acid dispersant is adsorbed onto the inorganic particles while being in a negatively charged state in the coating layer forming composition, so that the dispersion stability of the coating layer forming composition may be increased. Accordingly, the coating layer forming composition may be advantageous in forming the thin film of the coating layer compared to a dispersant having the same weight average molecular weight.

The content of the dispersant may be about 1 part by weight to 5 parts by weight relative to 100 parts by weight of the total weight of the inorganic particles. For example, the content of the dispersant may be about 1 part by weight or more, about 1.5 parts by weight or more, about 2 parts by weight or more, or about 2.5 parts by weight or more relative to 100 parts by weight of the total weight of the inorganic particles, and may be about 5 parts by weight or less, about 4.5 parts by weight or less, about 4 parts by weight or less, about 3.5 parts by weight or less, or about 3 parts by weight or less. When the content of the dispersant satisfies the above range, the dispersant is sufficiently present in the coating layer forming composition, and as described above, the dispersant may be adsorbed over a large amount of inorganic particles. Accordingly, the dispersion stability of the coating layer forming composition may be excellent. When the content of the dispersant satisfies the above range, the dispersant is sufficiently supplied into the coating layer forming composition, thereby preventing an increase in agglomeration between inorganic particles. Accordingly, the dispersion stability of the coating layer forming composition may be excellent. Also, when the content of the dispersant satisfies the above range, it is possible to prevent an increase in agglomeration between dispersants which may occur due to an excessive amount of dispersant. Accordingly, the viscosity of the coating layer forming composition may be kept sufficiently low.

According to one embodiment of the present disclosure, the coating layer forming composition may have a viscosity of about 5 cp to 30 cp, which is measured at a temperature of 25° C. and a shear rate of 10 rpm. For example, the viscosity of the coating layer forming composition, which is measured at a temperature of 25° C. and a shear rate of 10 rpm, may be about 5 cp or more, about 10 cp or more, about 11 cp or more, about 12 cp or more, about 13 cp or more, about 14 cp or more, or about 15 cp or more, and may be about 30 cp or less, about 25 cp or less, about 20 cp or less, or about 15 cp or less. The coating layer forming composition is a non-Newtonian fluid, and exhibits a so-called dilatant flow in which shear stress increases as a shear rate increases. Thus, the viscosity may vary depending on the temperature and shear rate. When the viscosity measured at a temperature of 25° C. and a shear rate of 10 rpm satisfies the above range, the coating layer forming composition may have good flowability at 25° C., which is the application temperature of the coating layer forming composition. Therefore, the coating layer forming composition may be advantageous in applying the coating layer with an even and thin thickness onto the porous polymer substrate. Also, when the viscosity of the coating layer forming composition satisfies the above range, the drying process of the coating layer forming composition may be readily performed and the manufacturing process of the separator for the electrochemical device may be shortened. Accordingly, the economic efficiency of the process may be excellent.

According to one embodiment of the present disclosure, the average particle size (D₅₀) of the solids in the coating layer forming composition may be about 1 μm to 1.5 μm. For example, the average particle size of the solids of the coating layer forming composition may be about 1 μm or more, about 1.1 μm or more, about 1.2 μm or more, about 1.3 μm or more, or about 1.4 μm or more, and may be about 1.5 μm or less, about 1.4 μm or less, or about 1.3 μm or less. When the average particle size of the solids of the coating layer forming composition satisfies the above range, the average specific surface area of particles in the coating layer forming composition, such as inorganic particles, a binder, and a dispersant, may also be high, and accordingly, the interaction between particles may be increased. Then, the dispersion stability of the coating layer forming composition may be excellent. Therefore, the coating workability of the coating layer forming composition may be excellent, and it may be easy to form a coating layer with an even and thin thickness during a coating process. Also, when the average particle size satisfies the above range, a sedimentation phenomenon of particles may be effectively prevented compared to when the particle size is excessively large.

According to one embodiment of the present disclosure, the solid content of the coating layer forming composition may be about 30 wt % to 35 wt %. For example, the solid content of the coating layer forming composition may be about 30 wt % or more, about 31 wt % or more, or about 32 wt % or more, and may be about 35 wt % or less, about 34 wt % or less, or about 33 wt % or less. When the solid content of the coating layer forming composition satisfies the above range, since the viscosity of the coating layer forming composition may satisfy the above-described range, the thin film of the coating layer is easily formed. Also, as described above, the drying process of the coating layer forming composition may be readily performed and the manufacturing process of the separator for the electrochemical device may be shortened, and accordingly, the economic efficiency of the process may be excellent.

According to one embodiment of the present disclosure, the content of the solvent in the coating layer forming composition may be about 60 wt % to 80 wt %. When the content of the solvent satisfies the above range, the coating layer forming composition may have a viscosity within the above-described range, and thus may be advantageous in forming the thin film of the coating layer. Also, the drying of the coating layer forming composition is easy and the manufacturing process of the separator for the electrochemical device may be shortened. Accordingly, the economic efficiency of the process may be excellent. Meanwhile, the solvent may be an aqueous solvent, and the aqueous solvent may be at least one selected from polar solvents such as water, methanol, ethanol, ethylene glycol, diethylene glycol and glycerol. When the aqueous solvent is used, in addition to an advantage of eco-friendliness, there is an advantage in that the facility may be simplified compared to the case where an organic solvent is used.

According to one embodiment of the present disclosure, the content of the inorganic particles may be about 80 parts by weight to 99 parts by weight relative to 100 parts by weight of the total solids of the coating layer forming composition. For example, the content of the inorganic particles may be about 80 parts by weight or more, about 85 parts by weight or more, about 90 parts by weight or more, or about 95 parts by weight or more, relative to 100 parts by weight of the total solids of the coating layer forming composition and may be about 99 parts by weight or less, about 98 parts by weight or less, about 97 parts by weight or less, about 96 parts by weight or less, about 95 parts by weight or less, about 94 parts by weight or less, about 93 parts by weight or less, about 92 parts by weight or less, about 91 parts by weight or less, or about 90 parts by weight or less. When the content of the inorganic particles satisfies the above range, the inorganic particles may be sufficiently included in the coating layer prepared from the coating layer forming composition, thereby minimizing the thermal shrinkage problem of the porous polymer substrate in the electrochemical device separator.

According to one embodiment of the present disclosure, the inorganic particle may be at least one selected from alumina (Al₂O₃), boehmite (AlO(OH)), BaTiO₃, Pb(Zr,Ti)O₃(PZT), Pb₁₋ₓLaₓZr_{1-y}Ti_{y}O₃(PLZT, 0<x<1, 0<y<1), Pb(Mg_{1/3}Nb_{2/3})O₃—PbTiO₃(PMN-PT), hafnia (HfO₂), SrTiO₃, SnO₂, CeO₂, MgO, Mg(OH)₂, NiO, CaO, ZnO, ZrO₂, SiO₂, Y₂O₃, SiC, Al(OH)₃, TiO₂, aluminum peroxide, zinc tin hydroxide (ZnSn(OH)₆), tin-zinc oxide (Zn₂SnO₄, ZnSnO₃), antimony trioxide (Sb₂O₃), antimony tetroxide (Sb₂O₄), and antimony pentoxide (Sb₂O₅). For example, the inorganic particle may be alumina. The inorganic particles may not undergo oxidation and/or reduction reactions in the operating voltage range of the electrochemical device (e.g., 0 V to 5 V based on Li/Li⁺). When the coating layer forming composition and the coating layer formed therefrom include the above-described inorganic particles, the thermal shrinkage problem of the electrochemical device separator may be effectively improved due to the high heat resistance of the above-described inorganic particles.

According to one embodiment of the present disclosure, the content of the binder may be about 0.5 parts by weight to 10 parts by weight relative to 100 parts by weight of the total solids of the coating layer forming composition. For example, the content of the binder may be about 0.5 parts by weight or more, about 1 part by weight or more, about 1.5 parts by weight or more, or about 2 parts by weight or more relative to 100 parts by weight of the total solids of the coating layer forming composition, and may be about 10 parts by weight or less, about 9 parts by weight or less, about 8 parts by weight or less, about 7 parts by weight or less, about 6 parts by weight or less, or about 5 parts by weight or less. When the content of the binder satisfies the above range, the interstitial volume, which is formed through interconnection of the inorganic particles by the binder, may be effectively increased. As a result, the porosity of the finally formed coating layer may be high. Also, since the inorganic particles are fixed by the binder, even during long-term operation of the electrochemical device, the porosity of the coating layer may be stably maintained. Furthermore, the adhesive strength between the coating layer and the electrode may also be improved by the binder.

According to one embodiment of the present disclosure, the binder may be at least one selected from polyvinylidene fluoride-co-hexafluoropropylene, polyvinylidene fluoride-co-trichloroethylene, polymethyl methacrylate, polyacrylonitrile, polyvinylpyrrolidone, polyvinyl acetate, poly(ethylene-co-vinyl acetate), polyethylene oxide, cellulose acetate, cellulose acetate butyrate, cellulose acetate propionate, cyanoethyl pullulan, cyanoethyl polyvinyl alcohol, cyanoethyl cellulose, cyanoethyl sucrose, pullulan, carboxyl methyl cellulose, acrylonitrile-styrene butadiene copolymer, polyimide, and styrene-butadiene rubber. When the coating layer forming composition and the coating layer formed therefrom include the above-described binder, the separator for the electrochemical device may have excellent adhesive strength to the electrode due to high adhesive strength of the above-described binder.

The present disclosure provides a manufacturing method of an electrochemical device separator.

In the manufacturing method of the electrochemical device separator, the coating layer forming composition is used. For example, the method includes the step of forming a coating layer on at least one surface of a porous polymer substrate by using the coating layer forming composition. In the manufacturing method of the electrochemical device separator according to one embodiment of the present disclosure, the contents overlapping with the description for the coating layer forming composition will be omitted.

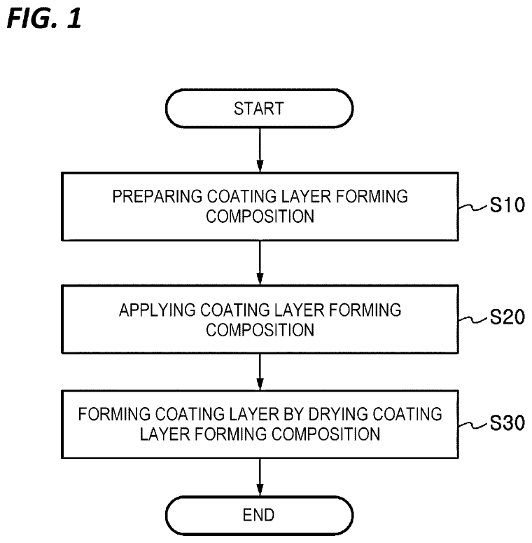

The present disclosure will be described in more detail with reference to FIG. 1.

The manufacturing method of the electrochemical device separator according to one embodiment of the present disclosure includes: the step (S20) of applying the coating layer forming composition to at least one surface of a porous polymer substrate; and the step (S30) of forming a coating layer by drying the coating layer forming composition. In the step (S20) of applying the coating layer forming composition, the coating layer forming composition may be applied at a speed of about 3 mpm to 10 mpm.

According to one embodiment of the present disclosure, the manufacturing method of the electrochemical device separator may further include the step (S10) of preparing the coating layer forming composition. In the step (S10) of preparing the coating layer forming composition, inorganic particles, a binder, a dispersant, and a surfactant may be prepared, the prepared inorganic particles, binder, dispersant, and surfactant may be added to, for example, ultra-pure distilled water (DIW), at a predetermined weight ratio, and then, the inorganic particles may be crushed and dispersed to prepare the coating layer forming composition.

The composition applying step (S20) is the step of applying the coating layer forming composition to at least one surface of the porous polymer substrate, and in this step, the coating layer forming composition may be applied by using various methods such as bar coating, dip coating, die coating, roll coating, comma coating or a mixed method thereof. For example, in the step (S20) of applying the coating layer forming composition, the coating layer forming composition may be applied to at least one surface of the porous polymer substrate through bar coating at a speed of about 3 mpm (meter per minute) to 10 mpm. For example, in the step (S20) of applying the coating layer forming composition, the coating layer forming composition may be applied onto the porous polymer substrate at a speed of about 3 mpm or more, 4 mpm or more, 5 mpm or more, or 6 mpm or more, and the coating layer forming composition may be applied onto the porous polymer substrate at a speed of about 10 mpm or less, about 9 mpm or less, about 8 mpm or less, about 7 mpm or less, about 6 mpm or less, about 5 mpm or less, or about 4 mpm or less. Since the coating layer forming composition has shear thickening properties, depending on the coating speed of the coating layer forming composition, it may be possible to form a thin film, or it may be difficult to form a coating layer itself. In the present disclosure, when the coating layer forming composition is applied to one surface of the porous polymer substrate at the above speed, the coating layer forming composition having shear thickening properties may be smoothly applied to one surface of the porous polymer substrate, and accordingly it may be possible to form a coating layer of a thin film with an even and thin thickness. When the coating speed of the coating layer forming composition falls within the above range, the thin-film coating layer may be easily formed while the economic efficiency of the process may be maintained. Also, when the coating speed of the coating layer forming composition falls within the above range, the thickness of the coating layer may be maintained at a thin level while a coating layer having a uniform thickness may be applied due to shear thickening properties of the coating layer forming composition.

According to one embodiment of the present disclosure, in the step (S20) of applying the coating layer forming composition, the coating layer forming composition may be applied at a temperature of about 20° C. to 30° C. For example, in the step (S20) of applying the composition, the coating layer forming composition may be applied at a temperature of about 20° C. or more, 22.5° C. or more, or about 25° C. or more, and the coating layer forming composition may be applied at a temperature of about 30° C. or less, about 27.5° C. or less, or about 25° C. or less. When the coating layer forming composition is applied in the above temperature range, the viscosity in the application of the coating layer forming composition may satisfy the above-described range, and accordingly, the flowability of the coating layer forming composition may be improved. Then, it may be easy to form a uniform thin-film coating layer.

According to one embodiment of the present disclosure, in the step (S20) of applying the coating layer forming composition, the porous polymer substrate may be driven at a speed of about 10 mpm to 50 mpm. For example, the driving speed of the porous polymer substrate may be about 10 mpm or more, about 20 mpm or more, or about 30 mpm or more, and may be about 50 mpm or less, about 40 mpm or less, or about 30 mpm or less. When the porous polymer substrate is driven at the above speed, the productivity of the porous polymer substrate may be increased compared to a case where the driving speed is excessively slow. Also, when the porous polymer substrate is driven at the above speed, the coating layer may be applied to one surface or both surfaces of the porous polymer substrate with a uniform and thin thickness compared to a case where the driving speed is excessively fast.

In the step (S30) of forming the coating layer by drying the coating layer forming composition, the coating layer forming composition applied to at least one surface of the porous polymer substrate through the composition applying step (S20) may be dried, so that the coating layer may be formed on at least one surface of the porous polymer substrate. During drying in the coating layer forming step (S30), the solvent present in the coating layer forming composition may be removed so that the thin film of the coating layer containing the inorganic particles, the binder, the dispersant, and the like, may be formed.

According to one embodiment of the present disclosure, in the coating layer forming step (S30), the coating layer forming composition may be dried at a temperature of about 50° C. to 70° C. For example, the drying temperature may be about 50° C. or more, about 55° C. or more, or about 60° C. or more, and may be about 70° C. or less, about 65° C. or less, or about 60° C. or less. When the drying temperature satisfies the above range in the coating layer forming step (S30), the solvent may be sufficiently removed, and thus the coating layer may be formed while being fixed to one surface of the porous polymer substrate. Also, since the heat applied to the coating layer forming composition is relatively low, there is an advantage in that the materials included in the coating layer such as the inorganic particles, the binder, and the dispersant as well as the porous polymer substrate are less deformed by heat.

In the coating layer forming step (S30), the coating layer forming composition may be dried for about 10 sec to 10 min. For example, in the coating layer forming step (S30), the drying time may be about 10 sec or more, about 30 sec or more, about 1 min or more, about 2 min or more, about 3 min or more, or about 4 min or more, and may be about 10 min or less, about 5 min or less, about 3 min or less, about 2 min or less, about 1 min or less, or about 30 sec or less. When the drying temperature and time satisfy the above ranges in the coating layer forming step (S30), the solvent may be sufficiently removed, and at the same time, there is an advantage in that particles included in the coating layer such as the inorganic particles, the binder, and the dispersant are less deformed by heat.

The present disclosure provides a separator for an electrochemical device.

The separator for the electrochemical device may be manufactured from the above-described coating layer forming composition, and may be manufactured through the above-described manufacturing method of the electrochemical device separator. In the electrochemical device separator according to one embodiment of the present disclosure, the contents overlapping with the description for the coating layer forming composition and the manufacturing method of the electrochemical device separator will be omitted.

According to one embodiment of the present disclosure, the separator for the electrochemical device includes a porous polymer substrate and a coating layer disposed on at least one surface of the porous polymer substrate. The coating layer includes inorganic particles, a binder, and a dispersant. The dispersant may contain polyacrylic acid (PAA) having a weight average molecular weight of 200,000 g/mol to 500,000 g/mol, and the content of the dispersant may be 1 part by weight to 5 parts by weight, relative to 100 parts by weight of the total weight of the inorganic particles. The thickness of the coating layer may be 1.3 μm or less.

According to one embodiment of the present disclosure, the coating layer includes inorganic particles, a binder, and a dispersant. The dispersant may contain polyacrylic acid (PAA) having a weight average molecular weight of about 200,000 g/mol to 500,000 g/mol, and the content of the dispersant may be about 1 part by weight to 5 parts by weight relative to 100 parts by weight of the total weight of the inorganic particles. The thickness of the coating layer may be about 1.3 μm or less. In the separator for the electrochemical device, the coating layer includes a polyacrylic acid dispersant having a weight average molecular weight of about 200,000 g/mol to 500,000 g/mol, in the range of about 1 part by weight to 5 parts by weight relative to 100 parts by weight of the total weight of the inorganic particles, and thus, the coating layer may be a thin film with a thickness of about 1.3 μm or less.

For example, the thickness of the coating layer may be about 0.5 μm or more, about 0.6 μm or more, about 0.7 μm or more, about 0.8 μm or more, about 0.9 μm or more, or about 1 μm or more, and may be about 1.3 μm or less, about 1.2 μm or less, about 1.1 μm or less, about 1 μm or less, about 0.9 μm or less, or about 0.8 μm or less. When the thickness of the coating layer satisfies the above range, lithium ions may more smoothly pass through the coating layer due to a low thickness of the coating layer. Accordingly, there is an advantage in that the resistance of the electrochemical device separator is low. Furthermore, since the total thickness of the electrochemical device separator including the coating layer may also be low, the electrochemical device including the electrochemical device separator may include a relatively large amount of electrode active materials. Accordingly, the energy density of the electrochemical device may also be high.

According to one embodiment of the present disclosure, the porosity of the coating layer may be about 30 vol % to 60 vol %. For example, the porosity of the coating layer may be about 30 vol % or more, about 35 vol % or more, about 40 vol % or more, or about 45 vol % or more, and may be about 60 vol % or less, about 55 vol % or less, about 50 vol % or less, or about 45 vol % or less. When the porosity of the coating layer satisfies the above range, since pores may be sufficiently present in the coating layer, lithium ions may smoothly move through the pores. Accordingly, the resistance of the electrochemical device separator may be low. Also, compared to a case where the porosity of the coating layer is excessively high and there are too many pores in the coating layer, the electrochemical device separator of the present disclosure may be excellent in the mechanical strength such as perforation strength.

According to one embodiment of the present disclosure, the average diameter (D₅₀) of the inorganic particles may be about 300 nm to 800 nm. For example, the average diameter of the inorganic particles may be about 300 nm or more, about 400 nm or more, or about 500 nm or more, and may be about 800 nm or less, about 700 nm or less, about 600 nm or less, or about 500 nm or less. When the diameter of the inorganic particles satisfies the above range, sufficient gaps may exist between the inorganic particles packed within the coating layer. Thus, the porosity and air permeability of the coating layer may be excellent. Therefore, since lithium ions may smoothly move through the coating layer, the resistance of the electrochemical device separator including the coating layer may be low. Furthermore, when the diameter of the inorganic particles satisfies the above range, the dispersibility of the inorganic particles within the coating layer forming composition may be excellent, and the thickness of the coating layer produced therefrom may also be thin.

According to one embodiment of the present disclosure, the porous polymer substrate may be a porous film in which a plurality of pores is formed, and may prevent an electrical short between a cathode and an anode through electrical insulation. For example, when the electrochemical device is a lithium secondary battery, the porous polymer substrate may be an ion-conducting barrier that blocks electrical contact between the cathode and the anode while allowing lithium ions to pass. At least a part of the pores may form a three-dimensional network through which the surface of the porous polymer film communicates with the inside, and then a fluid can pass through the porous polymer substrate via the pores.

As for the porous polymer substrate, a material physically and chemically stable against an electrolyte that is an organic solvent may be used. For example, the porous polymer substrate may include resins such as polyolefin-based resins, such as, for example, polyethylene, polypropylene and polybutylene, polyvinyl chloride, polyethylene terephthalate, polycycloolefin, polyethersulfone, polyamide, polyimide, polyimide amide, nylon, polytetrafluoroethylene and copolymers or mixtures thereof, but are not limited thereto. According to one embodiment, the polyolefin-based resin may be used. The polyolefin-based resin is suitable for manufacturing an electrochemical device with higher energy density because the resin can be processed into a relatively thin thickness and allows easy application of the coating layer forming composition.

The porous polymer substrate may have a single-layer or multi-layer structure. The porous polymer substrate may include two or more polymer resin layers with different melting points (Tm), thereby providing a shutdown function in the event of a high temperature thermal runaway of a battery. For example, the porous polymer substrate may include a polypropylene layer having a relatively high melting point and a polyethylene layer having a relatively low melting point. According to one embodiment, the porous polymer substrate may have a three-layer structure in which polypropylene, polyethylene, and polypropylene are sequentially stacked. The polyethylene layer melts as the temperature of the battery is increased to a predetermined temperature or more, so that the pores may be shut down, thereby preventing the thermal runaway of the battery.

According to one embodiment of the present disclosure, the thickness of the porous polymer substrate may be about 6 μm to 15 μm. For example, the thickness of the porous polymer substrate may be about 6 μm or more, about 8 μm or more, or about 10 μm or more, and may be about 15 μm or less, about 13 μm or less, about 11 μm or less, or about 9 μm or less. By controlling the thickness of the porous polymer substrate within the above-described range, the volume of the electrochemical device may be minimized while the cathode and the anode may be electrically insulated, and then the amount of active materials included in the electrochemical device may be increased.

According to one embodiment of the present disclosure, the porous polymer substrate may include pores having an average diameter of about 0.01 μm to 1 μm. For example, the size of pores included in the porous polymer substrate may be about 0.01 μm or more, about 0.02 μm or more, about 0.03 μm or more, or about 0.04 μm or more, and may be about 1 μm or less, about 0.09 μm or less, about 0.08 μm or less, about 0.07 μm or less, or about 0.06 μm or less. According to one embodiment, the size of the pores may be about 0.02 μm to 0.06 μm. By controlling the pore size of the porous polymer substrate within the above-described range, it is possible to control the air permeability and ionic conductivity of the entire separator to be manufactured.

The porous polymer substrate may have an air permeability of about 10 s/100 cc to 100 s/100 cc. For example, the air permeability of the porous polymer substrate may be about 10 s/100 cc or more, about 20 s/100 cc or more, about 30 s/100 cc or more, about 40 s/100 cc or more, or about 50 s/100 cc or more, and may be about 100 s/100 cc or less, about 90 s/100 cc or less, about 80 s/100 cc or less, about 70 s/100 cc or less, about 60 s/100 cc or less, or about 50 s/100 cc or less. According to one embodiment, the air permeability of the porous polymer substrate may be about 50 s/100 cc to 70 s/100 cc. When the air permeability of the porous polymer substrate falls within the above-described range, the air permeability of the manufactured separator may be provided within a range suitable for securing the output and cycle characteristics of the electrochemical device.

The air permeability (s/100 cc) refers to the time (sec) it takes for 100 cc of air to pass through a porous polymer substrate or a separator having a predetermined area under a constant pressure. The air permeability may be measured using an air permeability tester (Gurley densometer) in accordance with ASTM D 726-58, ASTM D726-94 or JIS-P8117. For example, 4110 N equipment of Gurley may be used to measure the time it takes for 100 cc of air to pass through a 1-square-inch (or 6.54 cm²) sample under a pressure of 0.304 kPa of air or 1.215 kN/m² of water. For example, EG01-55-1MR equipment of Asahi Seiko may be used to measure the time it takes for 100 cc of air to pass through a 1-square-inch sample under a constant pressure of 4.8 inches of water at room temperature.

The porous polymer substrate may have a porosity of about 10 vol % to 70 vol %. For example, the porosity of the porous polymer substrate may be about 10 vol % or more, about 20 vol % or more, about 30 vol % or more, or about 40 vol % or more, and may be about 70 vol % or less, about 60 vol % or less, or about 50 vol % or less. According to one embodiment, the porosity of the porous polymer substrate may be about 40 vol % to 60 vol %. When the porosity of the porous polymer substrate falls within the above-described range, the ionic conductivity of the manufactured separator may be provided within a range suitable for securing the output and cycle characteristics of the electrochemical device.

The above-described porosity refers to the volume ratio of pores to the total volume in each of the coating layer and the porous polymer substrate. The porosity may be measured by a method known in the present technical field. For example, the measurement may be performed by a Brunauer Emmett Teller (BET) measurement method using adsorption of nitrogen gas, a capillary flow porometer, or a water or mercury intrusion method.

The present disclosure provides an electrochemical device.

The electrochemical device may include the above-described separator for the electrochemical device.

According to one embodiment of the present disclosure, the electrochemical device includes a cathode, an anode and the separator for the electrochemical device, and the separator for the electrochemical device may be interposed between the cathode and the anode. In the electrochemical device according to one embodiment of the present disclosure, the contents overlapping with the description for the coating layer forming composition, the manufacturing method of the electrochemical device separator, and the separator for the electrochemical device will be omitted.

The electrochemical device is a device that converts chemical energy into electrical energy through an electrochemical reaction, and has a concept that encompasses a primary battery and a secondary battery. The secondary battery is chargeable and dischargeable, and refers to a lithium secondary battery, a nickel-cadmium battery, a nickel-hydrogen battery, etc. The lithium secondary battery uses lithium ions as an ion conductor. Examples thereof may include a non-aqueous electrolyte secondary battery including a liquid electrolyte, a solid-state battery including a solid electrolyte, a lithium polymer battery including a gel polymer electrolyte, and a lithium metal battery using a lithium metal as an anode, but are not limited to these.

Since the electrochemical device includes the above-described separator for the electrochemical device according to the present disclosure, lithium ions may smoothly move through the separator for the electrochemical device due to a low thickness of the coating layer. Thus, there is an advantage in that the resistance is low and the output is excellent.

According to one embodiment of the present disclosure, the cathode may include: a cathode current collector; and a cathode active material layer including a cathode active material, a conductive material and a binder resin, on at least one surface of the current collector. The cathode active material may include one type or a mixture of two or more types among layered compounds such as lithium manganese composite oxide (LiMn₂O₄, LiMnO₂, etc.), lithium cobalt oxide (LiCoO₂), and lithium nickel oxide (LiNiO₂) or compounds substituted with one or more transition metals; lithium manganese oxide such as chemical formulas Li₁₊ₓMn₂₋ₓO₄ (where x is 0 to 0.33), LiMnO₃, LiMn₂O₃, and LiMnO₂; lithium copper oxide (Li₂CuO₂); vanadium oxide such as LiV₃O₈, LiV₃O₄, V₂O₅, and Cu₂V₂O₇; Ni site-type lithium nickel oxide represented by a chemical formula LiNi₁₋ₓMₓO₂ (where M=Co, Mn, Al, Cu, Fe, Mg, B or Ga, and x=0.01 to 0.3); lithium manganese composite oxide represented by a chemical formula LiMn₁₋ₓMₓO₂ (where M=Co, Ni, Fe, Cr, Zn or Ta, and x=0.01 to 0.1) or Li₂Mn₃MO₈ (where M=Fe, Co, Ni, Cu or Zn); LiMn₂O₄ in which a part of Li in the chemical formula is substituted with an alkaline earth metal ion; a disulfide compound; and Fe₂(MoO₄)₃.

According to one embodiment of the present disclosure, the anode may include: an anode current collector; and an anode active material layer including an anode active material, a conductive material and a binder resin, on at least one surface of the current collector. The anode may include, as for the anode active material, one type or a mixture of two or more types selected from lithium metal oxides; carbon such as non-graphitizable carbon, or graphite-based carbon; metal composite oxides such as LixFe₂O₃ (0≤x≤1), Liₓ WO₂ (0≤x≤1), and SnₓMe₁₋ₓMe′_{y}O_{z} (Me: Mn, Fe, Pb, Ge; Me′: Al, B, P, Si, elements of groups 1, 2, and 3 of the periodic table, halogen; 0<x≤1; 1≤y≤3; 1≤z≤8); lithium metal; lithium alloys; silicon-based alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; Li—Co—Ni-based materials; and titanium oxide.

According to one embodiment of the present disclosure, the conductive material may be any one selected from, for example, graphite, carbon black, carbon fiber or metal fiber, metal powder, conductive whiskers, conductive metal oxide, activated carbon and polyphenylene derivatives, or a mixture of two or more types of conductive materials of these. According to one embodiment, the conductive material may be one type selected from natural graphite, artificial graphite, super-p, acetylene black, Ketjen black, channel black, furnace black, lamp black, thermal black, Denka black, aluminum powder, nickel powder, zinc oxide, potassium titanate and titanium oxide, or a mixture of two or more types of conductive materials of these.

According to one embodiment of the present disclosure, the current collector is not particularly limited as long as it has high conductivity without causing chemical changes in the corresponding battery. For example, stainless steel, copper, aluminum, nickel, titanium, calcined carbon, or aluminum or stainless steel whose surface is treated with carbon, nickel, titanium, silver, etc. may be used.

According to one embodiment of the present disclosure, the binder resin may be a polymer commonly used for electrodes in the art. Non-limiting examples of this binder resin may include polyvinylidene fluoride-co-hexafluoropropylene, polyvinylidene fluoride-co-trichloroethylene, polymethylmethacrylate, polyethylhexyl acrylate, polybutylacrylate, polyacrylonitrile, polyvinylpyrrolidone, polyvinylacetate, polyethylene-co-vinyl acetate, polyethylene oxide, polyarylate, cellulose acetate, cellulose acetate butyrate, cellulose acetatepropionate, cyanoethylpullulan, cyanoethylpolyvinylalcohol, cyanoethylcellulose, cyanoethylsucrose, pullulan and carboxyl methyl cellulose, and are not limited to these.

According to one embodiment of the present disclosure, a cathode slurry for producing the cathode active material layer may contain a dispersant. The dispersant may be a pyrrolidone-based compound, and specifically, may be N-methylpyrrolidone (ADC-01, LG chemical).

According to one embodiment of the present disclosure, the electrochemical device may further include an electrolyte. The electrolyte includes a salt having a structure such as A⁺B⁻, which may be dissolved or dissociated in an organic solvent, but the present disclosure is not limited thereto. A⁺ may include alkali metal cations such as Li⁺, Na⁺, and K⁺ or ions composed of combinations thereof. Also, B⁻ may include anions such as PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻, and C(CF₂SO₂)₃⁻ or ions composed of combinations thereof. The organic solvent includes propylene carbonate (PC), ethylene carbonate (EC), diethylcarbonate (DEC), dimethylcarbonate (DMC), dipropylcarbonate (DPC), dimethylsulfoxide, acetonitrile, dimethoxyethane, diethoxyethane, tetrahydrofuran, N-methyl-2-pyrrolidone (NMP), ethyl methyl carbonate (EMC), gamma butyrolactone or a mixture thereof.

In one embodiment of the present disclosure, a battery module including a battery including the electrochemical device as a unit cell, a battery pack including the battery module, and a device including the battery pack as a power source may be provided. Specific examples of the device may include: a power tool powered and driven by an electric motor; electric cars including an electric vehicle (EV), a hybrid electric vehicle (HEV), a plug-in hybrid electric vehicle (PHEV), etc.; electric two-wheeled vehicles including an electric bicycle (E-bike), and an electric scooter (E-scooter); an electric golf cart; and a power storage system, but are not limited thereto.

Hereinafter, the present disclosure will be described in detail with reference to examples. However, Examples according to the present disclosure may be modified in various different forms, and the scope of the present disclosure is not construed as being limited to Examples described below. Examples of the present specification are provided to more completely illustrate the present disclosure, to those having average knowledge in the art.

### EXAMPLES AND COMPARATIVE EXAMPLES

### Preparation of Coating Layer Forming Composition

### Preparation Example 1

Alumina (AES11, Sumitomo Co., Ltd., particle diameter (D50): 500 nm) as inorganic particles, a particulate acrylic binder (CSB140, Toyo Co., Ltd.) as a binder, polyacrylic acid having a weight average molecular weight of 345,000 g/mol as a dispersant (CK-702, Lubrizol Corporation), and a surfactant (BYK348, BYK) were prepared. The prepared inorganic particles, binder, dispersant, and surfactant were added to 231.6 g of ultra-pure distilled water (DIW) at a weight ratio of 95.6:2.5:1:0.9, and then the inorganic particles were crushed and dispersed to prepare a coating layer forming composition (solid content of 30 wt %). The viscosity of the coating layer forming composition, which was measured at a temperature of 25° C. and a shear rate of 10 rpm (viscosity measurement equipment: LV model viscometer (using UL Adapter), Brookfield), was 13.2 cp, and the average particle size (D₅₀) of the solids of the coating layer forming composition was 1.43 μm.

### Preparation Example 2

A coating layer forming composition was prepared in the same manner as in Preparation Example 1 except that in Preparation Example 1, the prepared inorganic particles, binder, dispersant, and surfactant were added to 230 g of ultra-pure distilled water (DIW) at a weight ratio of 95.1:2.5:1.5:0.9, and then the inorganic particles were crushed and dispersed to prepare a coating layer forming composition (solid content of 30 wt %). The viscosity of the coating layer forming composition, which was measured at a temperature of 25° C. and a shear rate of 10 rpm, was 13.8 cp, and the average particle size (D₅₀) of the solids of the coating layer forming composition was 1.44 μm.

### Preparation Example 3

A coating layer forming composition was prepared in the same manner as in Preparation Example 1 except that in Preparation Example 1, the prepared inorganic particles, binder, dispersant, and surfactant were added to 228.5 g of ultra-pure distilled water (DIW) at a weight ratio of 94.6:2.5:2:0.9, and then the inorganic particles were crushed and dispersed to prepare a coating layer forming composition (solid content of 30 wt %). The viscosity of the coating layer forming composition, which was measured at a temperature of 25° C. and a shear rate of 10 rpm, was 13.8 cp, and the average particle size (D₅₀) of the solids of the coating layer forming composition was 1.43 μm.

### Comparative Preparation Example 1

A coating layer forming composition was prepared in the same manner as in Preparation Example 1 except that in Preparation Example 1, the prepared inorganic particles, binder, dispersant, and surfactant were added to 233.1 g of ultra-pure distilled water (DIW) at a weight ratio of 96.1:2.5:0.5:0.9, and then the inorganic particles were crushed and dispersed to prepare a coating layer forming composition (solid content of 30 wt %). The viscosity of the coating layer forming composition, which was measured at a temperature of 25° C. and a shear rate of 10 rpm, was 12.6 cp, and the average particle size (D₅₀) of the solids of the coating layer forming composition was 1.41 μm.

### Comparative Preparation Example 2

A coating layer forming composition was prepared in the same manner as in Example 1 except that in Preparation Example 1, the prepared inorganic particles, binder, dispersant, and surfactant were added to 219.3 g of ultra-pure distilled water (DIW) at a weight ratio of 91.6:2.5:5:0.9, and then the inorganic particles were crushed and dispersed to prepare a coating layer forming composition (solid content of 30 wt %). The viscosity of the coating layer forming composition, which was measured at a temperature of 25° C. and a shear rate of 10 rpm, was 30.6 cp, and the average particle size (D₅₀) of the solids of the coating layer forming composition was 1.59 μm.

### Comparative Preparation Example 3

A coating layer forming composition was prepared in the same manner as in Preparation Example 1 except that in Preparation Example 1, polyacrylic acid (CK732, Lubrizol Corporation) having a weight average molecular weight of 6,000 g/mol was prepared as the dispersant, the prepared inorganic particles, binder, dispersant, and surfactant were added to 233.6 g of ultra-pure distilled water (DIW) at a weight ratio of 95.6:2.5:1:0.9, and then the inorganic particles were crushed and dispersed to prepare a coating layer forming composition (solid content of 30 wt %). The viscosity of the coating layer forming composition, which was measured at a temperature of 25° C. and a shear rate of 10 rpm, was 12.0 cp, and the average particle size (D₅₀) of the solids of the coating layer forming composition was 1.87 μm.

### Comparative Preparation Example 4

A coating layer forming composition was prepared in the same manner as in Preparation Example 1 except that in Preparation Example 1, polyacrylic acid having a weight average molecular weight of 600,000 g/mol was prepared as the dispersant, the prepared inorganic particles, binder, dispersant, and surfactant were added to 215.2 g of ultra-pure distilled water (DIW) at a weight ratio of 95.6:2.5:1:0.9, and then the inorganic particles were crushed and dispersed to prepare a coating layer forming composition (solid content of 30 wt %). The viscosity of the coating layer forming composition, which was measured at a temperature of 25° C. and a shear rate of 10 rpm, was 57.6 cp, and the average particle size (D₅₀) of the solids of the coating layer forming composition was 1.95 μm.

### Manufacturing of Separator for Electrochemical Device

A polyethylene film (thickness: 8.4 μm, air permeability: 62 s/100 cc) was prepared as a porous polymer substrate.

The porous polymer substrate was moved at a speed of 30 mpm, and the coating layer forming composition in Preparation Examples and Comparative Preparation Examples was applied to one surface of the porous polymer substrate being in driven by a bar-coating method. Specifically, the application of the coating layer forming composition was performed on the coating layer forming composition through a bar-coating method by using a doctor blade at a temperature of 25° C. Then, the application of the coating layer forming composition was performed while the coating speed of the doctor blade was changed to speeds of 1 mpm, 3 mpm, 5 mpm, 7 mpm, 10 mpm and 20 mpm. Thereafter, the applied coating layer forming composition was dried in wind at 70° C. by using a heat gun for 1 min, thereby forming a coating layer on one surface of the porous polymer substrate. Then, a separator for an electrochemical device was completed.

Hereinafter, the properties of the coating layer forming composition and the electrochemical device separator are noted in Table 1 below. The following wt % is described on the basis of the weight of the solids of the coating layer forming composition.

TABLE 1

| | | | | Comp. | Comp. | Comp. | Comp. |
|---|---|---|---|---|---|---|---|
| Coating layer | Preparation | Preparation | Preparation | Preparation | Preparation | Preparation | Preparation |
| forming composition | Example 1 | Example 2 | Example 3 | Example 1 | Example 2 | Example 3 | Example 4 |
| Inorganic particles (wt %) | 95.6 | 95.1 | 94.6 | 96.1 | 91.6 | 95.6 | 95.6 |
| Binder (wt %) | 2.5 | 2.5 | 2.5 | 2.5 | 2.5 | 2.5 | 2.5 |
| Dispersant (wt %) | 1 | 1.5 | 2 | 0.5 | 5 | 1 | 1 |
| Dispersant / Inorganic | 1.1 | 1.6 | 2.1 | 0.5 | 5.5 | 1.1 | 1.1 |
| particles (%) | | | | | | | |
| Molecular weight | 345,000 | 345,000 | 345,000 | 345,000 | 345,000 | 6,000 | 600,000 |
| (g/mol) of dispersant | | | | | | | |
| Viscosity | 13.2 | 13.8 | 13.8 | 12.6 | 30.6 | 12 | 57.6 |
| @25° C., 10 rpm (cp) | | | | | | | |
| Average particle size (μm) | 1.43 | 1.44 | 1.43 | 1.41 | 1.59 | 1.87 | 1.95 |

Thickness (μm) of coating layer depending on coating speed

| | | | | | | | | |
|---|---|---|---|---|---|---|---|---|
| Coating | 1 mpm | Unable to | Unable to | Unable to | Unable to | 2.14 | 1.81 | 2.15 |
| speed | | coat | coat | coat | coat | | | |
| | 3 mpm | 1.12 | 0.94 | 0.81 | 3.02 | 2.16 | 1.82 | 2.22 |
| | 5 mpm | 1.17 | 1.05 | 0.84 | 3.04 | 2.17 | 1.84 | 2.16 |
| | 7 mpm | 1.24 | 1.15 | 0.95 | 3.26 | 2.39 | 1.82 | 2.18 |
| | 10 mpm | 1.28 | 1.27 | 1.08 | 3.14 | 2.28 | 1.85 | 2.33 |
| | 20 mpm | 1.68 | 1.75 | 1.78 | 3.05 | 2.14 | 1.91 | 2.34 |

As noted in Table 1 above, it can be found that a coating layer of a thin film with a thickness of 1.3 μm or less was formed when the coating layer forming composition of Preparation Examples 1 to 3 was applied at a speed of 3 mpm to 10 mpm, in which the composition contained polyacrylic acid (PAA) having a weight average molecular weight of 345,000 g/mol (200,000 g/mol to 500,000 g/mol), as a dispersant, in an amount of 1.1% to 2.1% parts by weight relative to 100 parts by weight of the inorganic particles. Also, in the case of the coating layer forming composition of Preparation Example 3, it can be found that an ultra-thin-film coating layer having a thickness of 0.81 μm was formed at a coating speed of 3 mpm. From this, it can be found that a thin-film coating layer can be formed through the method of manufacturing the electrochemical device separator by using the coating layer forming composition of the present disclosure.

Meanwhile, it can be found that although the coating layer forming composition of Preparation Examples 1 to 3 was used, it was impossible to form a coating layer when the coating speed was 1 mpm or the thickness of a coating layer exceeded 1.6 μm when the coating speed was 20 mpm. Also, when the coating layer forming composition of Comparative Preparation Example 1 was used in which the content of the dispersant in the coating layer forming composition was 0.5%. It can be found that a thick coating layer having a thickness of 3.02 μm to 3.26 μm was formed at the same coating speed (3 mpm to 10 mpm) as that in Preparation Examples 1 to 3.

Furthermore, when the coating layer forming compositions of Comparative Preparation Examples 3 and 4 were used in which the dispersants had weight average molecular weights of 6,000 g/mol and 600,000 g/mol, respectively, it can be found that although the coating speeds were the same as those in Preparation Examples 1 to 3, relatively thick coating layers were formed with maximum thicknesses of 1.91 μm and 2.34 μm, respectively.

### Experimental Example

### (1) Measurement of Resistance of Separator

The electrochemical device separators (Examples 1 to 3) were produced by applying the coating layer forming composition of Preparation Example 3 at speeds of 3 mpm, 5 mpm and 7 mpm, respectively, the electrochemical device separator (Comparative Example 1) was produced by applying the coating layer forming composition of Preparation Example 3 at a speed of 20 mpm, the electrochemical device separators (Comparative Examples 2 to 4) were produced by applying the coating layer forming composition of Comparative Preparation Example 3 at speeds of 3 mpm, 5 mpm, and 7 mpm, respectively, and the electrochemical device separators (Comparative Examples 5 to 7) were produced by applying the coating layer forming composition of Comparative Preparation Example 4 at speeds of 3 mpm, 5 mpm, and 7 mpm, respectively. Each of these separators was interposed between SUS plates to fabricate a coin cell. The coin cell was injected with an electrolyte containing 1 M of LiPF₆ in a mixture of ethylenecarbonate:ethylmethylcarbonate at a volume ratio of 1:2. In order to measure the resistance of the coin cells, the resistance was measured through electrochemical impedance spectroscopy analysis results by using VMP3 of Bio-Logic Science Instruments at 25° C. under conditions of an amplitude of 10 mV and a scan range of 0.1 Hz to 1 MHz. The results are noted in Tables 2 and 3 below.

### (2) Measurement of Wet Shrinkage of Separator

The electrochemical device separators of Examples 1 to 3 and Comparative Examples 1 to 7 were prepared as test pieces with a size of 5 cm×5 cm, and each was inserted into an aluminum pouch with a size of 7 cm×10 cm. 1 g of the following electrolyte 1 was injected to the above pouch, and the pouch was sealed. The sealed pouch was stored in a 135° C. convection oven for 1 h, and then the separator was taken out. The thermal shrinkage in each of the MD direction and the TD direction was calculated in accordance with [(initial length of test piece−length after storage @135° C./1 h)/(initial length of test piece)]×100(%).

As the electrolyte, an electrolyte containing 1 mol of lithium salt LiPF₆ and 3 mol of vinylene carbonate (VC), 1.5 mol of propane sultone (PS), and 1 mol of ethylene sulfate (ESa) as additives, in a solvent containing a mixture of ethylene carbonate (EC)/ethyl methyl carbonate (EMC) at a weight ratio of 3/7, was used. The results are noted in Tables 2 and 3 below.

TABLE 2

| | | | | | Comp. | Comp. |
|---|---|---|---|---|---|---|
| Index | | Example 1 | Example 2 | Example 3 | Example 1 | Example 2 |
| Coating layer | Coating layer | Preparation | Preparation | Preparation | Preparation | Comp. |
| | forming composition | Example 3 | Example 3 | Example 3 | Example 3 | Preparation |
| | | | | | | Example 3 |
| | Coating speed (mpm) | 3 | 5 | 7 | 20 | 3 |
| | Thickness (μm) | 0.81 | 0.84 | 0.95 | 1.78 | 1.82 |

| | | | | | |
|---|---|---|---|---|---|
| Electrical resistance (Ω) | 0.62 | 0.61 | 0.63 | 0.84 | 0.88 |
| Thermal shrinkage of Wet state | 8/9 | 7/7 | 8/9 | 5/6 | 5/5 |
| @135° C./1 h (MD(%)/TD(%)) | | | | | |

TABLE 3

| | | Comp. | Comp. | Comp. | Comp. | Comp. |
|---|---|---|---|---|---|---|
| Index | | Example 3 | Example 4 | Example 5 | Example 6 | Example 7 |
| Coating layer | Coating layer | Comp. | Comp. | Comp. | Comp. | Comp. |
| | forming composition | Preparation | Preparation | Preparation | Preparation | Preparation |
| | | Example 3 | Example 3 | Example 4 | Example 4 | Example 4 |
| | Coating speed (mpm) | 5 | 7 | 3 | 5 | 7 |
| | Thickness (μm) | 1.84 | 1.82 | 2.22 | 2.16 | 2.18 |

| | | | | | |
|---|---|---|---|---|---|
| Electrical resistance (Ω) | 0.89 | 0.88 | 0.97 | 0.96 | 0.96 |
| Thermal shrinkage of Wet state | 5/5 | 5/5 | 4/4 | 3/4 | 3/4 |
| @135° C./1 h (MD(%)/TD(%)) | | | | | |

As noted in Tables 2 and 3 above, it can be found that the electrochemical device separator of Examples produced through the coating layer forming composition and the separator manufacturing method of the present disclosure includes a thin-film coating layer at a thickness level of 0.81 μm to 0.95 μm, and thus, has a lower electrical resistance compared to Comparative Examples in which a thicker coating layer is included. Specifically, the electrical resistance in Examples 1 to 3 was at the level of 0.61Ω to 0.63Ω whereas the electrical resistance in the case of Comparative Examples was at the level of 0.84Ω to 0.97Ω.

Also, in the case of Examples 1 to 3, the thickness of the thin-film coating layer is at the level of 0.81 μm to 0.95 μm, and at this level of thickness, the thermal shrinkage problem of the porous polymer substrate can be reduced. Thus, it can be found that the thermal shrinkage of the separator is sufficiently low compared to Comparative Examples in which the thickness of the coating layer is thick.

Although the above descriptions have been made with reference to embodiments of the present disclosure, it will be understood by those of ordinary skill in the art in the relevant technical field or those having ordinary knowledge in the relevant technical field that various modifications and changes can be made to various embodiments of the present disclosure within a scope that does not depart from the technical scope of various embodiments of the present disclosure described in the claims to be described below. Therefore, the technical scope of various embodiments of the present disclosure should not be limited to the contents described in the detailed description of the specification, but should be determined by the claims.

What is claimed is:

1. A composition for forming a coating layer comprising:
inorganic particles, a binder, a solvent, and a dispersant,
wherein the dispersant includes polyacrylic acid (PAA) having a weight average molecular weight of 200,000 g/mol to 500,000 g/mol, and
the content of the dispersant is 1 part by weight to 5 parts by weight relative to 100 parts by weight of the total weight of the inorganic particles.

2. The composition according to claim 1, wherein the viscosity of the coating layer forming composition measured at a temperature of 25° C. and a shear rate of 10 rpm is 5 cp to 30 cp.

3. The composition according to claim 1, wherein an average particle size (D₅₀) of the solids of the coating layer forming composition is 1 μm to 1.5 μm.

4. The composition according to claim 1, wherein the solid content of the coating layer forming composition is 30 wt % to 35 wt %.

5. The composition according to claim 1, wherein the content of the inorganic particles is 80 parts by weight to 99 parts by weight relative to 100 parts by weight of the total solids of the coating layer forming composition.

6. The composition according to claim 1, wherein the content of the binder is about 0.5 parts by weight to 10 parts by weight relative to 100 parts by weight of the total solids of the coating layer forming composition.

7. A method of manufacturing a separator for an electrochemical device, the method comprising:
applying the composition for forming a coating layer according to claim 1 to at least one surface of a porous polymer substrate; and
forming a coating layer by drying the composition for forming a coating layer,
wherein in the applying the composition, the composition is applied at a speed of 3 mpm to 10 mpm.

8. The method of manufacturing a separator for an electrochemical device according to claim 7, wherein in the applying the composition, the porous polymer substrate is driven at a speed of 10 mpm to 50 mpm.

9. The method of manufacturing a separator for an electrochemical device according to claim 7, wherein in the forming the coating layer, the composition is dried at a temperature of 50° C. to 70° C.

10. The method of manufacturing a separator for an electrochemical device according to claim 7, the method further comprising:
preparing the composition before the applying the composition.

11. A separator for an electrochemical device, the separator comprising:
a porous polymer substrate; and
a coating layer disposed on at least one surface of the porous polymer substrate,
wherein the coating layer includes inorganic particles, a binder, and a dispersant,
the dispersant contains polyacrylic acid (PAA) having a weight average molecular weight of 200,000 g/mol to 500,000 g/mol, and
the content of the dispersant is 1 part by weight to 5 parts by weight relative to 100 parts by weight of the total weight of the inorganic particles, and
the thickness of the coating layer is 1.3 μm or less.
